(19) United States
(12) Patent Application Publication
(10) Pub. No.: US 2001/0038691 A1
(43) Pub. Date: Nov. 8, 2001

(54) Method of establishing a connection, as well as exchange and communications network

(76) Inventors: Wolfgang Lautenschlager, Weissach-Flacht (DE); Lothar Krank, Leonberg (DE); Uwe Stahl, Leonberg (DE)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 09/902,145

(22) Filed: Jul. 10, 2001

Related U.S. Application Data
(63) Continuation of application No. 09/099,230, filed on Jun. 17, 1998.

(30) Foreign Application Priority Data
Jun. 19, 1997 (DE) 197 26 004.7

(51) Int. Cl. H04M 7/00; H04M 3/42

(52) U.S. Cl. 379/221.03; 379/207.02

(57) ABSTRACT

The invention relates to a method of establishing a connection between a calling subscriber (A) and a called subscriber (B) as well as to an exchange (EX1) and a communications network for carrying out the method. To establish the connection, a connection request is routed from a terminal (TE1) of the calling subscriber (A) to the exchange (EX1) of the communications network. To determine the route to the called subscriber (B), the exchange (EX1) accesses a central first control unit (SCP) common to two or more exchanges which executes a first routing procedure and communicates the result to the exchange (EX1). The exchange (EX1) monitors the central first control unit (SCP) or the connection to the central first control unit (SCP) for failures. When it detects such a failure, it accesses a second control unit (PROZ2) in the exchange (EX1) which executes an alternative second routing procedure instead of the first routing procedure.

This invention relates to a method of establishing a connection between a calling subscriber and a called subscriber as set forth in the preamble of claim 1, to an exchange of a communications network as set forth in the preamble of claim 12, and to a communications network with at least one exchange as set forth in the preamble of claim 13.

In conventional connection setup procedures, a connection request is routed to the terminal of the called subscriber by means of the called subscriber's number contained in the request. The called number determines the path through the communications network and, while passing through the communications network, is interpreted step by step by exchanges, i.e., it addresses first the local network area, then the subscriber terminal exchange, and then the terminal of the called subscriber within the numbering range of the subscriber terminal exchange. The interpretation of the called number and the routing, i.e., the determination of the path between the calling subscriber and the called subscriber, are controlled by the control facilities of the exchanges involved in establishing the connection.

The invention is based on a connection setup procedure in a deregulated network environment as is proposed in a document of the Public Network Operators' Interest Group of Jun. 29, 1994, entitled “High Level Service Description for Number Portability”, as a possible solution for the implementation of number portability in the United Kingdom.

Such a connection setup procedure is necessary if the subscriber access networks of different network operators share the numbering range of one subscriber access area and number portability is required. “Number portability” as used herein means that a subscriber can change from one subscriber access network operator to another within his or here access network area, taking along his or her number to the new network operator. As a result, there is no longer a fixed association between the subscriber access network and the called subscriber number that can be determined from the number.

In this connection setup procedure, number portability is implemented by translation of the subscriber number by means of a central IN service (IN=Intelligent Network) for the exchanges of a subscriber access network. If a subscriber changes from a first network operator to a second network operator within a local network area and wants to take along his or her number, call forwarding will be implemented by means of this IN service. This IN service will then be accessed by the exchanges of the subscriber access network upon receipt of each connection request. The IN service will then determine whether and, if so, to which number the incoming connection request is to be routed.

One disadvantage of this solution is that on receipt of each connection request, access to a central unit, namely the IN service, must take place. A failure of this central unit would render the establishment of connections to a great number of subscribers impossible.

The object of the invention is to improve the fail-safety of the establishment of a connection in a communications system wherein at least one central control unit common to two or more exchanges is involved in the establishment of the connection.

This object is attained by a method of establishing a connection between a calling subscriber and a called subscriber according to the teaching of claim 1 and by an exchange and a communications network according to the teachings of claims 12 and 13, respectively.

The basic idea of the invention is to provide an exchange with additional functionality which detects any failure of the central unit, and then to switch to an alternative routing procedure which is incorporated in the exchange.

This approach ensures very high fail-safety which, as a rule, will be higher than the safety provided, for example, by the use of redundancy for central components.

The invention can be used not only for the establishment of connections in the above-described deregulated communications system but for all connection setup procedures which use a central routing control unit for two or more exchanges. Such central control units are used, for example, in the UPT concept (UPT=Universal Personal Telecommunications) to translate a logical subscriber number into a physical network address. Further examples of such central control units are service control units for freephone services, universal number services, VPN services, or emergency call services.

The alternative routing procedure is preferably a simple, but less comfortable or less expensive routing procedure which can maintain emergency operation. Such a simple routing procedure, which does not require a complex database system, for example, can be incorporated at low cost into any of the exchanges. Since it is resorted to in only a small number of cases, its less comfortable mode of operation and the costs incurred by its implementation are of secondary importance. The method according to the invention can thus be implemented at lower cost than, for example, the provision of redundancy for central components.

The invention will become more apparent from the following description of two embodiments taken in conjunction with the accompanying drawings, in which:

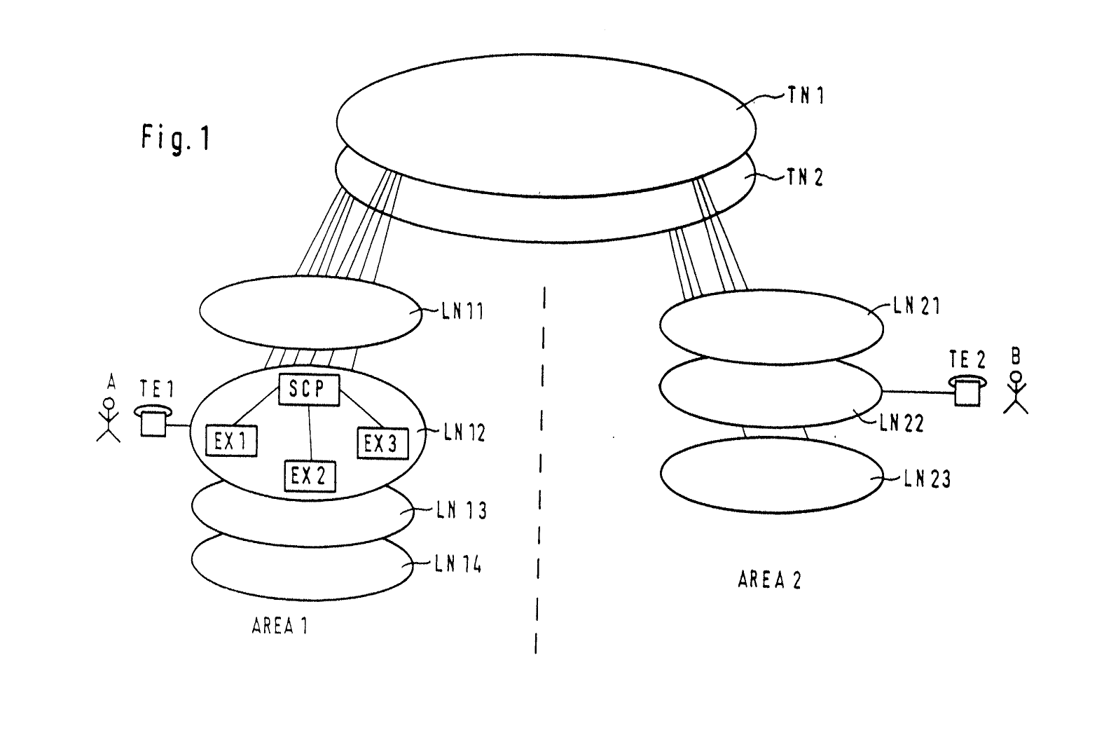

FIG. 1 shows part of a deregulated communications system with a communications network according to the invention; and

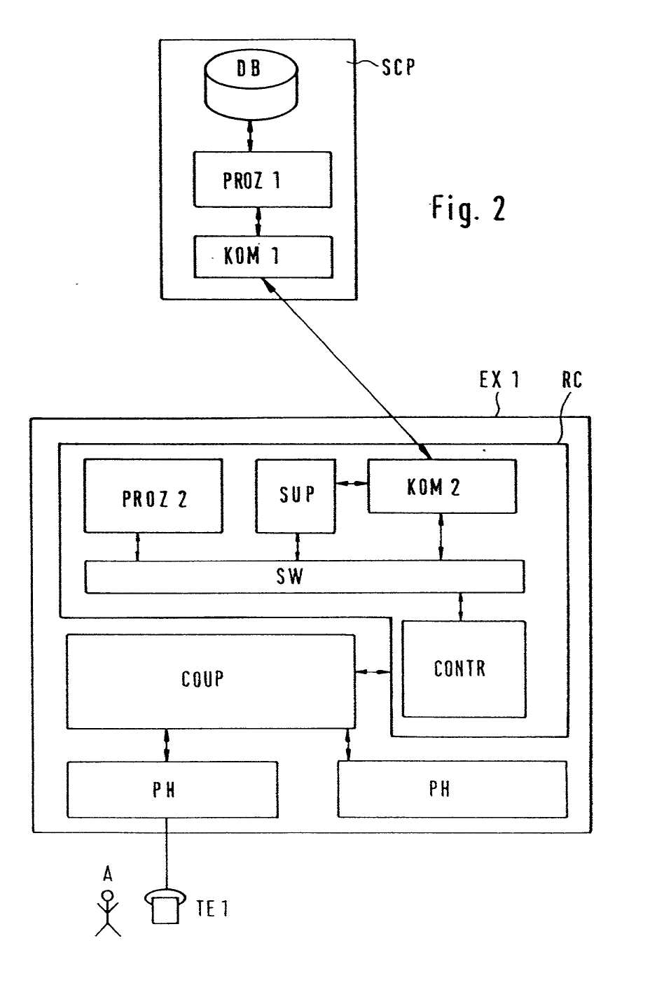

FIG. 2 is a block diagram with an exchange according to the invention which forms part of the communications network of FIG. 1.

In the first embodiment, the implementation of the method of establishing a connection in accordance with the invention in a deregulated communications environment in a communications network with one or more exchanges in accordance with the invention will be explained.

FIG. 1 shows a part of a communications system with two communications networks TN1 and TN2 and seven subscriber access networks LN11 to LN23. Via the subscriber access networks LN11 to LN14 and LN21 to LN23, the terminals of a subscriber access area AREA1 and a subscriber access area AREA2, respectively, are connected to the communications system. Of these terminals, only the terminal TE1 of a subscriber A and the terminal TE2 of a subscriber B are shown here by way of example. Terminal TE1 is connected to subscriber access network LN12, and terminal TE2 to subscriber access network LN22.

The communications networks TN1 and TN2 represent trunk networks, which serve to provide telephone connections between exchanges. The communications networks TN1 and TN2 are connected to the subscriber access networks LN11 to LN14 of the subscriber access area AREA1 and to the subscriber access networks LN21 to LN23 of the subscriber access area AREA2, so that connections between access networks of different subscriber access areas can be established via each of the communications networks TN1 and TN2.

It is also possible to connect the subscriber access networks LN11 to LN23 to only one trunk network, in which case there is no possibility of choosing a particular trunk network and, thus, a particular trunk network operator.

The subscriber access networks LN11 to LN23 are conventional access networks for connecting telephone terminas and private branch exchanges to the communications system. Possible telephone terminals are telephones, fax machines, but also modems and interface cards for the connection of data processing systems. The terminals may be both analog and ISDN terminals (ISDN=Integrated Services Digital Network).

The terminals TE1 and TE2 are such terminals.

Each of the subscriber access networks LN11 to LN23 contains one or more subscriber terminal exchanges. Of the exchanges of the subscriber access networks LN11 to LN23, three exchanges EX1 to EX3, which form part of the subscriber access network LN12, are shown here by way of example. All terminals of subscribers associated with one of the subscriber access networks LN11 to LN23 are connected by subscriber lines to such a subscriber terminal exchange of the respective subscriber access network. Larger subscriber access networks, because of the greater amount of traffic to be carried, may also include transit exchanges. The exchanges of a subscriber access network are connected with one another and with one or more transit exchanges of the communications networks TN1 and TN2 by trunks.

Exchanges of the subscriber access networks LN11 to LN14 or LN21 to LN23 may also be interconnected by trunks.

The subscriber access networks LN11 to LN23 may also be radiocommunications-networks, e.g. networks based on the GSM standard (GSM Global System for Mobile Communications) or the DECT standard (DECT=Digital Enhanced Cordless Telephone). Such radio interfaces may also form part of one or more exchanges of one of the subscriber access networks LN11 to LN23, i.e., only part of the subscribers of this subscriber access network are connected to the communications system via one or more radiocommunications networks.

The subscriber access networks LN11 to LN14 and LN21 to LN23 are assigned to different network operators.

The subscriber access networks LN11 to LN14 and LN21 to LN23, covering the same subscriber access areas AREA1 and AREA2, respectively, e.g., the same local network area, share the numbering ranges of the subscriber access areas AREA1 and AREA2, respectively.

The subscriber access networks LN11 to LN14 and LN21 to LN23 are thus available to the subscribers residing in the same geographical area via the same trunk code in parallel. The subscribers can thus select via which of the subscriber access networks LN11 to LN14 or LN21 to LN23 their respective terminals are connected to the communications system, and can determine by this selection the subscriber access network operator and, thus, the conditions effective for the subscriber terminal.

The exchanges EX1 to EX3 are exchanges which perform the functions of service switching points. On receipt of a connection request with a specific service indicator as a called number, or generally on receipt of connection requests from particular or all terminals, these exchanges access a central control unit SCP which then provides functions for the further routing of the connection request, and thus for the establishment of the connection. The central control unit SCP forms part of the subscriber access network LN12 and is connected to all those exchanges of the subscriber access network LN12 which perform the function of a service switching point. Such service switching points may be subscriber terminal exchanges, but also transit exchanges.

The subscriber access network LN12 may also include two or more central control units SCP which are each connected to a subgroup of service switching points of the subscriber access network LN12. Another possibility is to provide one central control unit which is connected to service switching points of two or more subscriber access networks of different network operators. Such a central control unit may be operated by an independent control unit operator which charges the different network operators for its services.

It is advantageous that the interworking between the exchanges EX1 to EX3 and the central control unit SCP takes place in accordance with the IN architecture (IN=Intelligent Network), with the exchanges EX1 to EX3 playing the roles of service switching points, and the central control unit SCP playing the role of a service control point.

In the following, the establishment of a connection between subscriber A and subscriber B will be described by way of example.

Subscriber A dials a logical number assigned to subscriber B. This logical number is sent in a connection request from the terminal TE1 to the subscriber access network LN12, where it is automatically routed to the exchange EX1.

Upon receipt of this connection request, the exchange EX1 directs a query with the logical number to the central control unit SCP, which determines from the logical number the physical number at which subscriber B can be reached. This physical number can simply be another subscriber number if number portability is implemented by call forwarding.

Other physical numbers are possible. For instance, the physical number may consist of the logical number and an indicator identifying the operator of the destination subscriber access network.

The physical number determined by the central control unit SCP is then inserted by the exchange EX1 into the connection request in place of the logical number. The connection to the terminal TE2 is then established in the usual manner by successive interpretation of the connection request, which now contains the physical number determined by the central control unit SCP.

It is also possible to carry out the translation of the logical number into the physical number in a service switching point of one of the communications networks TN1, TN2 or in a service switching point of one of the subscriber access network LN21 to LN23 of the destination subscriber access area AREA2. This service switching point would then cooperate, in the same manner as the service switching point EX1, with a central control unit common to one or more service switching points which is of the same design as the control unit SCP.

Each of the exchanges EX1 to EX3 monitors whether the central control unit SCP and the connection to the central control unit SCP are operational. If a failure of the central control unit SCP or the connection is detected, the respective one of the exchanges EX1 to EX3 will switch to an alternative internal routing procedure. This internal routing function will then control the determination of the phaysical number of the terminal TE2.

The detailed operation of the exchange EX1 and the central control unit SCP will now be explained by way of example with reference to FIG. 2.

FIG. 2 shows the central control unit SCP, the exchange EX1, and the terminal TE1.

The control unit SCP contains a communications unit KOM1, a function unit PROZ1, and a database DB.

The communications unit KOM1 comprises all software and hardware functions for communication with the service switching points EX1 to EX3, preferably in accordance with the IN architecture.

The database DB contains data which assigns one or more physical numbers to the logical number of each of the subscribers in deregulated subscriber access areas, for example in the subscriber access areas AREA1 and AREA2.

The function unit PROZ1 executes a procedure which determines, by means of the database DB, the physical number for a logical number received in a request via the communications unit KOM1, and which then sends this physical number via the communications unit to that of the exchanges EX1 to EX3 from which the request with the logical number was sent. For the assignment of the physical number, the database is searched for the received logical number by means of a search algorithm, and the associated physical number is then interpreted.

The exchange contains two line units PH, a switching network COUP, and a routing control facility RC.

The line units PH provide functions which permit the connection of terminals to the network and particularly the connection of trunk groups running to other exchanges. Via the line units PH, the exchanges EX2 to EX3 and exchanges of the communications networks TN1 and TN2 are connected by trunk groups to the exchange EX1, for example.

The line units PH and the control facility RC exchange data via the switching network COUP.

The control facility RC controls the switching network COUP. It contains two control units CONTR and PROZ2, a communications unit KOM2, a monitoring unit SUP, and a switching unit SW.

The functions of the control units CONTR and PROZ2, the monitoring unit SUP, and the switching unit SW are implemented by control programs which run on the data processing platform of the exchange EX1.

The communications unit KOM2 provides the communications functions for communication with the control unit SCP analogously to the communications unit KOM1.

The control facility CONTR controls the connection setup through the exchange EX1. It monitors the connection requests arriving at the exchange EX1 for the presence of a logical number to be translated. When it detects such a connection request, it sends a request to determine the associated physical number through the communications unit KOM2 to the control unit SCP or directly to the control unit PROZ2 incorporated in the control facility RC. That of these two control units to which the request is sent and which thus executes the procedure for determining the physical number is determined by the switching unit SW.

It is also possible that each connection request arriving at the exchange EX1 initiates the transmission of a request and that the control unit SCP determines whether the number is a number to be translated. Furthermore, it is possible that the connection request is first routed normally through the subscriber access network and that the connection request will be routed to the exchange EX1 and a query will be directed to the service control unit SCP only if it is determined that no normal subscriber can be reached at the number (“query on release”).

The control unit CONTR assists the control unit SCP or PROZ2 in executing the respective procedure, e.g., by entering the determined physical number in the connection request and routing the connection request with the physical number onward for the purpose of establishing the connection.

The control unit PROZ2 executes a second procedure for determining the physical number which is different from the procedure of the function unit PROZ1.

A first possibility for such a procedure is for the control unit PROZ2 to establish a connection back to the terminal TE1 and request subscriber A to enter further information concerning the physical number of the terminal TE2. The request may be in the form of a prerecorded voice message which is transmitted over an established information channel, and a voice recognition unit may be provided on the side of the control unit PROZ2 for converting spoken information entered by the subscriber. It is also possible to carry out this communication via a signaling channel, e.g. by a request to dial further digits or by transmitting text messages over the ISDN D channel.

Further information on the physical number may be the operator indicator (“carrier selection”), which is then used to form the physical number by adding the logical number. It is also possible to enable subscriber A to enter the physical number directly or to calculate the physical number from the operator indicator or from other information on subscriber B.

A procedure according to this first possibility does without a complex database and is thus easy to implement on the platform of the exchange EX1. In comparison with the procedure of the control unit SCP, however, user friendliness is limited, which, however, is of no importance because there is little probability that the procedure is actually used.

A second possibility is for the procedure to reroute the connection request to a service switching point connected to another central control unit. An advantageous priority sequence for such rerouting is to first attempt to reroute the connection request to a service switching point of the same subscriber access network LN12 and only then effect rerouting to a service switching point of a subscriber access network or of a trunk network of another network operator.

A procedure according to the second possibility does not limit user friendliness but may result in overloading of central control units and in extra costs to the operator of the subscriber access network LN12, which however, is of no importance, either, because there is little probability of the procedure being used.

A third possibility for such a procedure is to initiate several attempts to establish connections to possible physical numbers. For example, successive attempts are made to establish the connection to subscriber B through the subscriber access networks LN21 to LN23 of the destination subscriber access area AREA2. The destination subscriber access area is determined by the logical number of subscriber B. Thus, to form the physical numbers for the call attempts, the control unit PROZ2 only needs to hold the operator indicators of the subscriber access networks present in this destination subscriber access area.

If the control unit PROZ2 receives a positive reply, i.e., if such a call attempt is successful, it will stop making further call attempts to the remaining subscriber access networks. The order in which the call attempts are made may be selected at random or be fixed.

It is advantageous to determine these orders by statistical evaluation of attempts to establish connections to terminals of the destination subscriber access area. For example, first a call attempt through that subscriber access network of the destination subscriber access area through which the most connections are established is initiated. By continuous statistical evaluation of the establishment of connections to terminals of the various subscriber access areas, the order can be adapted to the subscriber behavior.

It is also possible to initiate call attempts to two or more subscriber access networks in parallel.

The monitoring unit SUP monitors the operation of the central control unit SCP and the connection between the exchange EX1 and the control unit SCP. This monitoring is implemented by arranging that upon transmission of a request from the communications unit KOM2 to the control unit SCP, a timer is started which monitors the receipt of the reply. If the reply does not arrive within a given period of time, the connection and the control unit will be considered inoperative and the switching unit will be instructed to switch from the control unit SCP to the control unit PROZ2. If the monitoring unit SUP receives from the control unit SCP a message indicating that the control unit and the connection are operative again, the switching unit will be instructed to switch from the control unit PROZ2 to the control unit SCP.

The monitoring unit SUP may also monitor the status of the control unit SCP and the connection to the control unit SCP in another manner, e.g. by regular transmission of monitoring messages which are looped back by the control unit SCP. Such monitoring messages may also be used exclusively to determine when the control unit SCP and the connection to the control unit SCP are operative again.

As stated above, the first embodiment may also be applied analogously to other connection setup procedures, exchanges, and communications networks in which a central control unit common to two or more exchanges is used for routing functions.

In a second embodiment of the invention, the central control unit provides a UPT service (UPT=Universal Personal Telecommunications) which translates a logical subscriber number into a physical network address. The logical subscriber number identifies the called subscriber, and the physical network address identifies that of two or more possible terminals at which the subscriber can be reached at the moment. In this embodiment, the central control unit, the exchanges connected to it, and the communications network comprising the exchanges are constructed as shown in FIG. 2. The only difference is that the data structure and the function unit PROZ1 are adapted to the specific UPT translation and are constructed in the same manner as for conventional methods in this area. The possible procedures implemented in the control unit PROZ2 are still limited to those possibilities which do not operate with an operator indicator.

1. A method of establishing a connection between a calling subscriber (A) and a called subscriber (B) wherein a connection request is routed from a terminal (TE1) of the calling subscriber (A) to an exchange (EX1) of a communications network (LN12), and wherein, to determine the route to the called subscriber (B), the exchange (EX1) accesses a central first control unit (SCP) common to two or more exchanges (EX1 to EX3) which executes a first procedure for determining the route and communicates the result to the exchange (EX1),
characterized in that the exchange (EX1) monitors the central first control unit (SCP) or the connection to the central first control unit (SCP) for failures and, when detecting such a failure, accesses a second control unit (PROZ2) which is incorporated in the exchange (EX1) and executes, instead of the first procedure, an alternative second procedure for determining the route.

2. A method as claimed in claim 1, characterized in that the first procedure determines, for a logical number of the called subscriber (B), a physical address of a subscriber terminal via which the called subscriber (B) can be reached, and communicates said physical address to the exchange (EX1).

3. A method as claimed in claim 2, characterized in that the second procedure requests the calling subscriber (A) to enter the physical address of the subscriber terminal.

4. A method as claimed in claim 1, characterized in that the first procedure determines, for a number of the called subscriber (B), that subscriber access network (LN22) of two or more possible subscriber access networks (LN21 to LN23) of different network operators sharing a common numbering range through which the called subscriber (B) can be reached.

5. A method as claimed in claim 4, characterized in that the second procedure requests the calling subscriber (A) to enter an identification code of the subscriber access network (LN22) of the called subscriber (B), and routes the connection request to said subscriber access network (LN22).

6. A method as claimed in claim 4, characterized in that the second procedure requests the calling subscriber (A) to enter a directory number with the identification code of the subscriber access network (LN22) of the called subscriber (B).

7. A method as claimed in claim 1, characterized in that the second procedure determines another exchange which accesses another central control unit which also executes the first procedure and causes the connection request to be routed to said other exchange.

8. A method as claimed in claim 1 characterized in that the second procedure determines a gateway to a communications network (LN11, LN13 to LN23, TN1 to TN2) of another network operator with another central control unit for determining the route, and causes the connection request to be routed to the communications network of said other network operator.

9. A method as claimed in claim 1, characterized in that the second procedure determines the communications network of the called subscriber (B) by attempting to establish one or more connections to one or more possible communications networks (LN21 to LN23), and causes the connection request to be routed to said communications network.

10. A method as claimed in claim 9, characterized in that the attempts to establish one or more connections are made in an order determined by evaluation of statistical data.

11. A method as claimed in claim 1, characterized in that the exchange (EX1) and the first control unit (SCP) represent, respectively, a service switching point and a service control point according to the IN architecture.

12. An exchange (EX1) of a communications network (LN12) with a communications unit (KOM2) for accessing a central first control unit (SCP) common to two or more exchanges (EX11 to EX13) and with a control facility (RC) which is adapted to access the central first control unit (SCP) via the communications unit (KOM2) for determining the route between a calling subscriber (A) and a called subscriber (B), which central first control unit (SCP) executes a first procedure for determining the route and communicates the result to the exchange (EX1),
characterized in that the control facility (RC) comprises a monitoring unit (SUP) for monitoring the central first control unit (SCP) or the connection to the central first control unit (SCP) for failures, that the control facility (RC) further comprises a second control unit (PROZ2) for executing an alternative second procedure for determining the route, and that the control facility (RC) is designed in such a way that upon detection of such a failure by the monitoring unit (SUP), it accesses the second control unit (PROZ2), which then executes the second procedure instead of the first procedure.

13. A communications network with at leat one exchange (EX1 to EX3) and with a central first control unit (SCP) common to two or more exchanges (EX1 to EX3), the at least one exchange (EX1 to EX3) being provided with a communications unit (KOM2) for accessing the central first control unit (SCP) and with a control facility (RC) which is adapted to access the central first control unit (SCP) via the communications unit (KOM2) for determining the route between a calling subscriber (A) and a called subscriber (B), which central first control unit (SCP) executes a first procedure for determining route and communicates the result to the exchange (EX1),
characterized in that the control facility (RC) comprises a monitoring unit (SUP) for monitoring the central first control unit (SCP) or the connection to the central first control unit (SCP) for failures, that the control facility (RC) further comprises a second control unit (PROZ2) for executing an alternative second procedure for determining the route, and that the control facility (RC) is designed in such a way that upon detection of such a failure by the monitoring unit (SUP), it accesses the second control unit (PROZ2), which then executes the second procedure instead of the first procedure.
